(19) United States
(12) Patent Application Publication
(10) Pub. No.: US 2018/0341262 A1
(43) Pub. Date: Nov. 29, 2018

(54) Drone-Based Active Protection System

(71) Applicant: Plasan Sasa Ltd., M.P. Marom Hagalil (IL)

(72) Inventor: Yehoshua Yeshurun, Haifa (IL)

(21) Appl. No.: 15/991,049

(22) Filed: May 29, 2018

(30) Foreign Application Priority Data
May 29, 2017 (IL) 252583

(51) Int. Cl. G05D 1/00; G05D 1/12; F41H 13/00; F42B 12/70; G01S 5/00; G01S 7/38; B64C 39/02

(52) U.S. Cl. CPC G05D 1/0094; G05D 1/0088; G05D 1/12; F41H 13/005; F41H 13/0093; B64C 2201/141; G01S 5/0072; G01S 7/38; B64C 39/024; B64C 2201/121; F42B 12/70

(57) ABSTRACT

A system for facilitating active protection of a target from a threat is provided. The system comprises one or more platforms configured for directing operation of the system, and one or more unmanned aerial vehicles (UAVs) configured to operate in the vicinity of the target, and to facilitate detection and/or neutralizing of the threat. The platform is configured for autonomously detecting and providing instructions for neutralizing the threat, and each of the unmanned aerial vehicles is configured for communicating with the platform.

### CROSS-REFERENCE TO RELATED APPLICATIONS

This application claims priority to Israel Patent Application No. 252583 filed on May 29, 2017, the disclosure of which is incorporated herein, in its entirety, by this reference.

### TECHNOLOGICAL FIELD

The presently disclosed subject matter related to protection systems for vehicles and other targets, in particular to systems configured for facilitating deployment of active protection.

### BACKGROUND

Active protection systems are typically provided to neutralize incoming threats to a target, such as armored vehicles, by destroying or diverting it, or otherwise removing the danger posed thereby. Active protection systems generally fall into two broad categories—hard-kill countermeasures and soft-kill countermeasures. The former usually involves neutralizing the threat by impacting it by other materials such as a projectile, and the latter usually involves exploiting physical properties associated with or relied on for operation of the threat (e.g., electromagnetic, acoustic, or other signature) to neutralize it.

For many kinds of countermeasures, the threat should be neutralized as far as is practical from the target. In some cases (in particular with hard-kill countermeasures), neutralization of the threat is accompanied by an explosion, which itself could damage the target if it occurs too closely thereto. In other cases (for example wherein the threat is diverted), a suitable distance is necessary to ensure that the neutralization properly occurs.

### SUMMARY

According to one aspect of the presently disclosed subject matter, there is provided a system for facilitating active protection of a target from a threat, the system comprising:
one or more platforms configured for directing operation of the system; and
one or more unmanned aerial vehicles (UAVs) configured to operate in the vicinity of the target, and to facilitate detection and/or neutralizing of the threat,
   wherein the platform is configured for autonomously detecting and providing instructions for neutralizing the threat, and wherein each of the UAVs is configured for communicating (e.g., directly, without relying on any system external thereto and/or to the target) with the platform (e.g., the platform being configured to issue instructions to the UAVs).

At least some of the UAVs may be configured to hover in a fixed location.

At least some of the UAVs may be fixed-wing aircraft.

At least some of the UAVs may each be connected to the platform and/or the target by a cable for being powered thereby.

At least some of the UAVs may be configured to receive power from the platform and/or the target wirelessly.

At least some of the UAVs may each comprise a battery.

At least some of the UAVs may comprise surveillance equipment configured to facilitate detection of the threat. The UAVs may be configured for transmitting surveillance data to the platform, the platform being configured for processing the surveillance data to detect the threat.

The surveillance equipment may comprise one or more selected from the group including an optical sensor, an infrared sensor, a motion sensor, a thermal sensor, and a pulse-Doppler radar.

The platform may be configured to communicate with an active protection system for directing operation thereof.

One or more of the UAVs may comprise the active protection system.

The platform may comprise the active protection system.

The active protection system may comprise one or more hard-kill countermeasures.

The hard-kill countermeasures may be selected from the group including one or more projectiles and a laser weapon (i.e., configured to emit a beam of directed energy).

One or more of the UAVs may be configured for intercepting the threat to neutralize it (i.e., the UAV itself constituting the hard-kill countermeasure).

The active protection system may comprise one or more soft-kill countermeasures.

The soft-kill countermeasures may be selected from the group including chaff, radar jamming, electromagnetic pulses, a laser dazzler, and a radio frequency decoy.

Each of the UAVs may comprise a location sensor configured to determine the absolute location thereof.

The system may be configured to determine the relative location of each of the UAVs with respect to the platform and/or other of the UAVs.

The platform may be configured for installation on the target.

The target may be a vehicle, for example an armored vehicle.

The system may be configured to implement machine learning to improve performance of at least one task.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1 is a schematic illustration of an active protection system according to the presently disclosed subject matter; and

FIG. 2 is a schematic illustration of an example of a configuration of the active protection system illustrated in FIG. 1.

### DETAILED DESCRIPTION

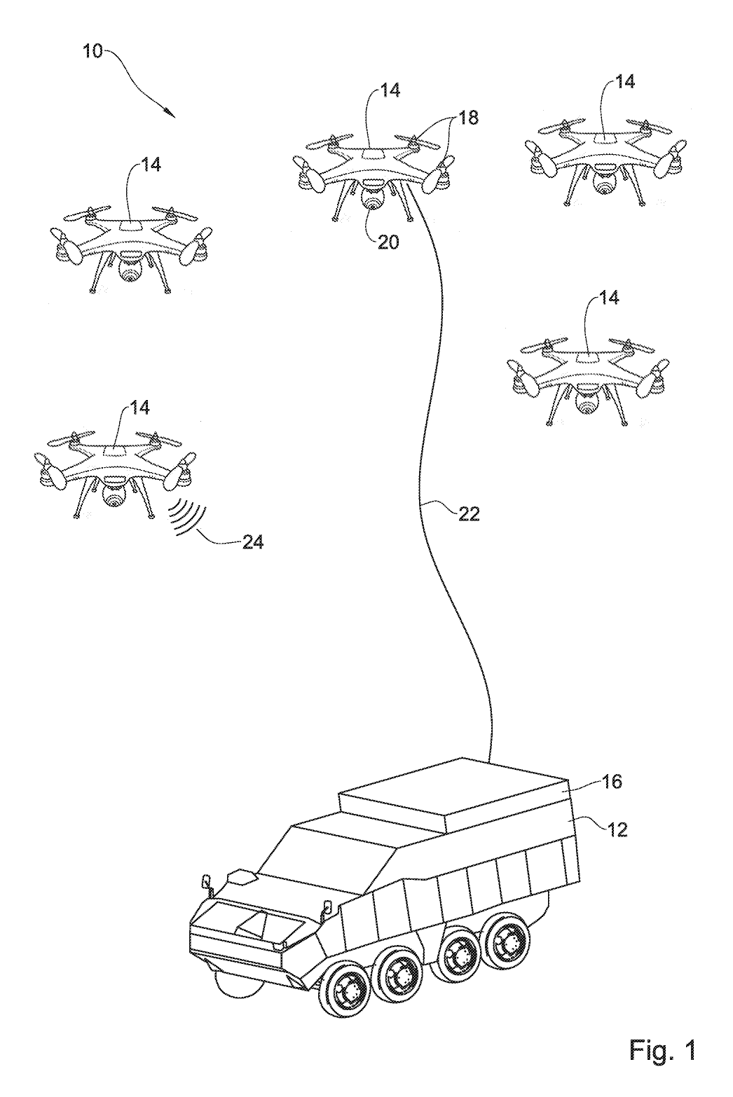

As illustrated in FIG. 1, there is provided a system, which is generally indicated at 10. The system 10 is configured to facilitate active protection of a target such as a vehicle 12, which may be a tank, a personnel carrier, a marine vehicle, an airborne vehicle, etc., from an incoming threat. The threats are typically projectiles, such as rockets, missiles, etc. While the vehicle 12 is not necessarily a component of the system 10, references herein to the system 10 may, for the sake of clarity, include the vehicle as well, unless otherwise clear from context. References to facilitating protection from a threat (including similar and/or related terms) may comprise some or all activities connected to an operation to neutralize a threat or to otherwise remove a target from being in danger therefrom, including, but not limited to, detecting the threat, destroying it, damaging it, diverting it, prematurely activating it, slowing it, etc.

It will be further appreciated that while the present disclosure and its accompanying drawing are directed toward a system for protecting a land-based vehicle, such a system may be provided for facilitating active protection of other potential targets, including, but not limited to, air vehicles, marine vehicles, buildings, outdoor venues, geographic locations, machinery, etc., without departing from the scope of the presently disclosed subject matter, mutatis mutandis.

The system 10 comprises one or more unmanned aerial vehicles (UAVs) 14, and at least one central platform 16, configured for coordinating operation of the system. According to some examples, the platform 16 may be configured for installation on the vehicle 12, for example being provided as an independent unit, e.g., configured for mounting on the vehicle 12, or it may be configured for integration with an existing system, e.g., of the vehicle (for example, it may comprise software which is installed on an existing processing unit, e.g., the mission computer, of the vehicle; in such a case, the vehicle itself constitutes the platform of the system). According to other examples, the platform 16 may be configured for being separate and/or remote from the vehicle 12, for example in a separate vehicle configured to maintain a close proximity to the vehicle, or in a separate location altogether. The platform thus comprises a system controller, which may be a dedicated controller, or part of a controller of an external system, for example one associated with the vehicle 12.

It will be appreciated that while herein the specification and claims, the term controller is used with reference to a single element, it may comprise a combination of elements, which may or may not be in physical proximity to one another, without departing from the scope of the presently disclosed subject matter, mutatis mutandis (i.e., the term controller is used as a logical description, not necessarily as a constructional description of a particular physical computing device). Furthermore, descriptions herein the specification and recitation in the appended claims of multiple controllers includes, and may be embodied in practice by, a single controller. Similarly, such descriptions include providing multiple controllers, with functions described herein as being assigned to a particular controller being carried out in practice by a different one of the controllers, without departing from the scope of the presently disclosed subject matter, mutatis mutandis. In addition, disclosure herein (including recitation in the appended claims) of a controller carrying out, being configured to carry out, or other similar language, implicitly includes other elements of the system 10 carrying out, being configured to carry out, etc., those functions, without departing from the scope of the presently disclosed subject matter, mutatis mutandis.

While the platform 16 is described herein with reference to and illustrated in the accompanying drawings as being associated with the vehicle 12, it will be appreciated that it may be associated with a different vehicle, a stationary location, etc., without departing from the scope of the presently disclosed subject matter, mutatis mutandis. It will be further appreciated that the platform 16 may be provided, mutatis mutandis, such that it is adapted for use with a land vehicle, a marine vehicle, an airborne vehicle such as one of the UAVs 14, etc., without departing from the scope of the presently disclosed subject matter.

The UAVs are configured to operate (i.e., physically fly during operation) in the vicinity of the vehicle 12, such that it may facilitate in rapidly detecting and/or neutralizing fast-moving threats, such as anti-tank missiles, etc. According to some examples, the vicinity may be considered to be within a distance which does not exceed that distance from which the threat is launched. According to other examples, the vicinity is within about 100 m (about 328 ft.). It will be appreciated that the specific distance may vary, for example exceeding about 100 m (about 328 ft.), but still being less than the distance from which the threat is launched.

Each of the UAVs 14 may be associated with a UAV controller (not illustrated) for directing its operation, in particular the operation of its elements, as will be described below. In addition, the UAV controller is configured to communicate, directly and/or indirectly, with elements of the UAV 14, for example to receive information and/or data therefrom, and/or to direct operation thereof. It may comprise one or more communications modules to facilitate transmission/receipt of data between elements of the UAV 14, other UAVs, the platform 16 (e.g., the platform controller), and/or external systems, e.g., to be directly controlled thereby.

The UAV controller may be provided as an element of the UAV 14 or externally thereto, for example on the platform 16, with elements of the UAV (for example as described below) configured for communicating therewith.

The UAVs 14 may each comprise a location sensor (not illustrated) in order to determine its location. According to some non-limiting examples, the location sensor is configured to determine the absolute location of the UAV 14, and may thus comprise a global positioning system (GPS) receiver. According to other non-limiting examples, the location sensor is configured to determine the location of the UAV 14 with relation to other elements of the system 10, such as other UAVs, the platform 16, the vehicle 12, and/or with relation to an external system. The location sensor may be further configured to determine the orientation of the UAV 14, absolutely and/or with respect to other elements of the system 10 and/or an external system.

According to further examples, the location sensor is configured to facilitate determining the absolute and/or relative location of the UAV 14, as described above. It may be further configured to utilize data regarding its relative position to other elements, together with GPS data from those elements, in order to refine the calculation of its absolute position, and/or vice versa.

According to some examples, each of the UAVs 14 is configured to move in any direction and/or to hover, i.e., to remain airborne in a single position. Accordingly, it may comprise a plurality of rotors 18 designed to cooperate to enable movement and/or hovering thereof. According to other examples (not illustrated), each of the UAVs may be a fixed-wing aircraft. According to further examples, the system 10 comprises both hovering and fixed-wing UAVs.

The system 10 is configured to detect an incoming threat. According to some examples, the platform 16 is configured to perform the detection. Information for facilitating the detection may be collected in any known way, for example using sensors associated with the platform 16 and/or with the vehicle 12, from an external source (e.g., surveillance vehicles, satellites, etc.), and/or from any other suitable source.

Alternatively or additionally, one or more of the UAVs 14 may comprise surveillance equipment 20 configured to facilitate detection of an incoming threat. The UAV 14 may be configured to transmit data gathered by the surveillance equipment 20 to the platform controller and/or the UAV controller for further processing (i.e., to identify the type of or specific threat, and/or to identify whether the threat's trajectory, and assess the likelihood of it impacting the vehicle and/or where on the vehicle the impact is likely to occur). The surveillance equipment 20 may comprise one or more of an optical sensor, infrared sensor, a motion sensor, a thermal sensor, and a pulse-Doppler radar. The surveillance equipment 20 may additionally or alternatively comprise any other device which is suitable to facilitate detection of an oncoming threat.

As mentioned, the platform controller may be configured to communicate with the surveillance equipment 20 and to analyze surveillance data collected thereby in order to determine the presence, identity, trajectory, and/or any other necessary parameter of an incoming threat. According to some examples, the platform controller is configured to utilize surveillance data collected from other sources, e.g., from other UAVs 14 in the system 10 and/or from an external system, in making the determination, either in addition to surveillance date received from the UAV 14 or in addition thereto.

It will be appreciated that any surveillance data may also include location data, e.g., associated with the device performing the surveillance.

According to some examples, multiple UAVs 14 may be configured to independently determine the presence, identity, trajectory, and/or any other necessary parameter of an incoming threat, and verify their determinations with those of the others. They may be configured to selectively perform this verification, e.g., based on the amount of time determined until impact of the threat. Similarly, the platform controller may be configured to make independent assessments of the presence, identity, trajectory, and/or any other necessary parameter of an incoming threat, each based on surveillance data from different subsets of sources (e.g., different UAVs, UAVs and external sources, etc.) and to verify the assessments with one another.

The platform 16 and/or one or more of the UAVs 14 may be configured to facilitate neutralizing a detected threat. They may be designed to accomplish this, e.g., by directing deployment of one or more countermeasures, by directly intercepting the threat, or by a combination of both. The platform 16/UAVs 14 may be further configured to monitor the threat to determine the success of the neutralization attempt, optionally directing deployment of a second countermeasure in the event of failure.

The countermeasure may be any suitable arrangement for neutralizing the threat before is impacts the vehicle 12. Typically, the countermeasure is designed to be effective to neutralize a specific type of threat. A threat may be considered to be neutralized if it no longer threatens the vehicle 12, or if its threat to the vehicle is reduced. This may include, inter alia, destruction of the threat, causing it to initiate prematurely and/or improperly, inhibiting its ability to initiate, diverting it, disturbing its stability, implementing countermeasures which interfere with its operation and/or guidance system, etc. A countermeasure may be configured to use one or several methods to neutralize a threat.

Accordingly, the platform 16 and/or one or more of the UAVs 14 may be configured to direct deployment of the countermeasure most suited against an identified threat, and/or to direct deployment of two or more types of countermeasures against a single threat.

According to some examples, the countermeasure is provided on one of the UAVs 14 itself, or on the platform 16, for deployment. According to some examples, the countermeasure is an external one, i.e., not deployed by the system 10 at all; rather, according to these examples a UAV 14 or other element of the system directs an external apparatus or system to deploy the countermeasure.

The countermeasures may comprise one or more hard-kill countermeasures including, but not limited to, projectiles, pellets, a laser weapon, etc. The countermeasures may comprise one or more soft-kill countermeasures including, but not limited to, chaff, radar jamming, one or more electromagnetic pulses, a laser dazzler, radio frequency decoys, etc.

According to some non-limiting examples, the platform 16 and/or one or more of the UAVs 14 carries one or more countermeasures, which may be of the same type or of different types. Accordingly, it may be configured to:
act autonomously to identify and deploy countermeasures to neutralize a threat;
utilize data from an external source, such as one or more of the other UAVs 14 of the system 10, to identify a threat which it then deploys countermeasures to neutralize; and/or
be directed to deploy countermeasures to neutralize a threat identified by an external source.

According to other non-limiting examples, the platform 16 and/or one or more of the UAVs 14 is configured to direct that one or more external countermeasures be deployed. The external countermeasure may be carried by another of the UAVs 14 or an external system. When directing the deployment of an external countermeasure, platform 16 and/or one or more of the UAVs 14 may further provide data regarding the identity, trajectory, and/or any other relevant parameter of the threat to the apparatus which deploys the countermeasure. The external countermeasure may be part of an active protection system of the vehicle 12.

According to further non-limiting examples, the system 10 is configured to neutralize the threat by directly intercepting it with one of the UAVs 14. According to some examples, the UAV 14 is be configured to utilize this option as a last resort, for example if time does not permit deployment of a different countermeasure, if no other countermeasures suitable for the threat are available, etc. Direct interception by a UAV 14 may be accomplished in one of several ways:
A UAV 14 may be configured to direct itself into the path of an incoming threat and/or to attract the threat away from the vehicle 12 and towards it.
Other elements of the system 10 (e.g., other UAVs 14 and/or the platform 16) may be configured to assume control of an intercepting UAV and direct it into the path of an incoming threat.

According to either of the above, other UAVs 14 and/or elements of the system 10 may be configured to monitor the threat to determine the success of the neutralization attempt.

According to some examples, some or all of the UAVs 14 may be functionally connected to other elements of the system 10, for example to receive power therefrom and/or to facilitate communication therebetween.

For example, some or all of the UAVs 14 may be functionally connected to the vehicle 12 or the platform 16 by a cable 22. In addition or alternatively, some or all of the UAVs 14 may be may be functionally connected thereto wirelessly, as indicated at 24, for example using microwave radiation, or by using multi-coil magnetic beamforming, for example as disclosed in “Magnetic MIMO: How to Charge Your Phone in Your Pocket” by Jouya Jadidian & Dina Katabi, published in “Proceedings of the 20th annual International Conference on Mobile Computing and Networking”, by the Association for Computing Machinery, Pages 495-506, the entire contents of which are incorporated herein by reference. It will be appreciated that some methods of wireless power transmissions may be used to facilitate determine the relative location of the UAV 14 with respect to the transmitter, mutatis mutandis.

According to some non-limiting examples, the UAV 14 is configured to operate directly on power supplied by other elements of the system 10 (e.g., via the cable 22, supplied wirelessly, etc.).

According to other non-limiting examples, the UAV 14 comprises a battery (not illustrated) for powering its operation, and is configured to utilize electrical power supplied by other elements of the system 10 to recharge the battery. According to some modifications, the UAV 14 may be configured to selectively use power directly supplied by other elements of the system 10 or from the battery, for example switching from battery power when functionally connected to other elements of the system (e.g., if the cable 22 becomes detached, if the wireless transmission is interrupted, etc.). According to these examples, the UAV 14 may comprise a battery which is smaller than one which would be required if no external source of power were available during flight. In addition, UAVs 14 according to these examples may operate disconnected from the cable 22 for a period of time if necessary (e.g., when directly intercepting an incoming threat).

As mentioned, the functional connection between the UAV 14 and other elements of the system 10 may include communication therebetween. The information may comprise one or more selected from the group including, but not limited to, data gathered thereby, data to gathered by other UAVs, instructions by and/or for the UAV for deployment of one or more countermeasures (for example as described above), etc.

According to some non-limiting examples, the UAV controller is configured to perform minimal processing of data gathered thereby, being configured to transmit raw data collected to another element of the system 10, such as the platform 14, for processing. This may lower the power required by the UAV 14, and may further enhance the overall processing efficiency of the system 10, as data collected by several UAVs 14 may be processed together, thereby eliminating the need to correlate information from each UAV 14 after initial processing thereby. In addition, there may be fewer constraints associated with providing the platform 16 with a more powerful processor than with providing the UAV 14 the same processor, as the costs (i.e., weight, power requirements, etc.) associated with processing power, such as power requirements, heat dissipation, weight of the hardware, additional hardware required to protect components in-flight, are typically more easily borne by the platform than by the UAV, or rendered unnecessary by their incorporation therein (for example, the platform may comprise a powerful processor for other functions thereof, which could be used to facilitate processing of data collected by a UAV).

The system 10 as described above with reference to and as illustrated in the accompanying figures relates to a platform 16 associated with one or more UAVs 14 to protect a vehicle 12. It will be appreciated that several modifications may be provided without departing from the scope of the presently disclosed subject matter, mutatis mutandis. According to some non-limiting examples, the system 10 may be configured to provide protection for several vehicles 12. In an event, e.g., that more than one vehicle 12 is threatened simultaneously, the system 10 may determine which of the vehicles is a higher priority for receiving protection. The determination may be based at least partially on the relative strategic value of the vehicle, the damage it is likely to sustain from the threat, relative to other vehicles, if not protected therefrom, etc.

According to other non-limiting examples, the system may comprise more than one platform 16. The platforms may be on the same vehicle 12, for example wherein one or more serves as a redundant platform, on different vehicles, for example wherein the system 10 provides protection for more than one vehicle, and/or of different types, for example wherein the system comprises a vehicle-based platform as well as an additional platform.

According to further non-limiting examples, each system 10 may be configured to operate together with other systems, for example exchanging data therebetween, directing one another to deploy countermeasures, etc.

According to other non-limiting examples, the system 10 may be configured to adapt to changes in the number of UAVs 14 operating therewith. For example, it may be configured to accommodate a newly added UAV 14 during operation or to relinquish one of its UAVs 14, e.g., to provide assistance for another system. Accordingly, each system 10 may be configured to communication with other systems, for example to request such assistance, and/or to evaluate its ability to provide it upon receipt of such a request.

According to some examples, the UAVs 14 may be configured to communicate among themselves in order to facilitate identifying and/or neutralizing a threat. For example, the UAVs 14 may operate independently (wholly or partially) of the platform 16, e.g., by processing surveillance data to identify the threat, and to direct operation of one of the UAVs 14 to act to neutralize it. They may share information, including, but not limited to, raw surveillance data and/or processed information, among themselves to facilitate accomplishing one or more of such tasks, thereby allowing some or all of the UAVs 14 to utilize information gathered by some or all of the other UAVs and/or the platform 16. Similarly, the system 10 may be designed such that the platform 16 issues instructions to the UAVs 14 to neutralize an identified threat (including information about the threat, e.g., location, trajectory, velocity, threat type, etc.), the UAVs being configured to communicate among themselves in order to determine operational details of the neutralizing, e.g., which UAV should act, etc.

It will be appreciated that the UAVs 14 and/or platform 16, when carrying out any operation (described herein or otherwise), may be configured to utilize statistical data, based on data gathered from some or all of the other elements of the system 10 or of other systems, in order to progressively improve their performance of one or more task. (Such improvements are often referred to as machine learning.) These improvements may relate to identification of threats, neutralizing threats, optimization of one or more of its operations, and/or any other suitable task.

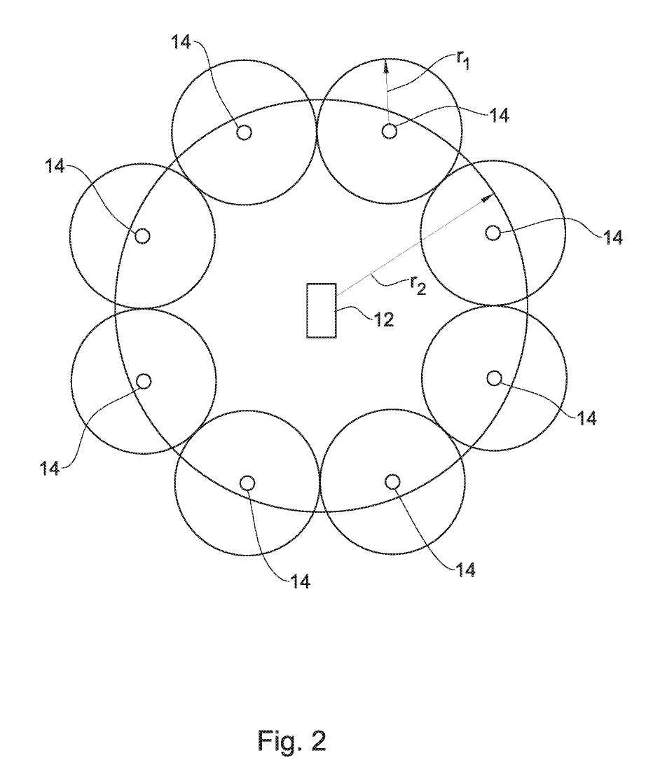

As illustrated schematically in FIG. 2, the system may be configured to operate such that several UAVs 14 surround the vehicle 12, each being configured to deploy a soft-kill countermeasure which extends a distance r₁ therefrom. As the UAVs 14 are spaced far from the vehicle 12, the combined protected area provided by the several UAVs 14 may neutralize a threat at a distance r₂, which is larger than r₁. As the amount of energy required to deploy the soft-kill countermeasure area increases with the distance which it extends from its source, by providing several smaller zones of protection (e.g., each of radius r₁) to effectively protect a larger zone (e.g., having radius r₂), the amount of energy required to effect protection to the area defined by the larger radius may be reduced, compared to that required if protection was provided by equipment disposed on the vehicle 12. Accordingly, the system 10 may be used to protect against threats which are at a large distance from the vehicle 12, while expending less energy than would be required to protect from such threats using equipment disposed on the vehicle itself. While the above has been described with reference to a soft-kill countermeasure, it will be appreciated that the same applied, mutatis mutandis, to a hard-kill countermeasure.

It will be appreciated that, e.g., in a situation wherein the direction of the threat is known, the system 10 may be deployed such that UAVs 14 do not completely surround the vehicle 12, but are disposed, for example, on one side thereof.

It will be appreciated that the system 10 may be configured to act autonomously, i.e., automatically and/or without user intervention, to detect and neutralize a threat. In addition, as the UAVs 14 may operate at a distance from the vehicle 12, use of the system 10 to contribute to protection thereof may result in neutralization of threats at distances which are farther from the vehicle than are typical wherein elements for detection and neutralization are located on the vehicle itself. As neutralization of threats may result in collateral damage to the vehicle 12 (e.g., neutralization of a missile may entail an explosion, which itself may cause damage to the vehicle if it occurs at too small a distance therefrom), increasing the distance at which threats may be neutralized may further protect the vehicle, and, in some cases, decrease the weight of protective armor necessary to shield the vehicle from such collateral damage.

Those skilled in the art to which this invention pertains will readily appreciate that numerous changes, variations, and modifications can be made without departing from the scope of the presently disclosed subject matter, mutatis mutandis.

1. A system for facilitating active protection of a target from a threat, the system comprising:
one or more platforms configured for directing operation of the system; and
one or more unmanned aerial vehicles (UAVs) configured to operate in a vicinity of the target, and to facilitate detection and/or neutralizing of said threat;
wherein said one or more platforms are configured for autonomously detecting and providing instructions for neutralizing said threat;
wherein each of said one or more UAVs is configured for communicating with said one or more platforms.

2. The system according to claim 1, wherein at least some of said one or more UAVs are configured to hover in a fixed location.

3. The system according to claim 1, wherein at least some of said one or more UAVs are fixed-wing aircraft.

4. The system according to claim 1, wherein at least some of said one or more UAVs are configured to receive power from said one or more platforms and/or said target.

5. The system according to claim 1, wherein at least some of said one or more UAVs comprise surveillance equipment configured to facilitate detection of said threat.

6. The system according to claim 5, wherein said one or more UAVs are configured for transmitting surveillance data to said one or more platforms, and wherein said one or more platforms are configured for processing said surveillance data to detect said threat.

7. The system according to claim 5, wherein said surveillance equipment comprises one or more of an optical sensor, an infrared sensor, a motion sensor, a thermal sensor, or a pulse-Doppler radar.

8. The system according to claim 1, where said one or more platforms are configured to communicate with an active protection system for directing operation thereof.

9. The system according to claim 8, wherein one or more of said one or more UAVs comprise said active protection system.

10. The system according to claim 8, wherein said one or more platforms comprise said active protection system.

11. The system according to claim 8, wherein said active protection system comprises one or more hard-kill countermeasures.

12. The system according to claim 11, wherein one or more of said one or more UAVs are configured for intercepting said threat to neutralize said threat.

13. The system according to claim 11, wherein said hard-kill countermeasures comprise at least one of one or more projectiles or a laser weapon.

14. The system according to claim 8, wherein said active protection system comprises one or more soft-kill countermeasures.

15. The system according to claim 14, wherein said soft-kill countermeasures comprise one or more of chaff, radar jamming, electromagnetic pulses, or a radio frequency decoy.

16. The system according to claim 1, wherein each of said one or more UAVs comprises a location sensor configured to determine an absolute location thereof.

17. The system according to claim 1, being configured to determine a relative location of each of the one or more UAVs with respect to the one or more platforms and/or other of the one or more UAVs.

18. The system according to claim 1, wherein said one or more platforms are configured for installation on said target.

19. The system according to claim 1, wherein said target comprises a vehicle.

20. The system according to claim 1, configured to implement machine learning to improve performance of at least one task.
